(19) United States
(12) Patent Application Publication
(10) Pub. No.: US 2026/0081773 A1
(43) Pub. Date: Mar. 19, 2026

(54) Selective Encryption for Processing-in-Memory

(71) Applicant: Advanced Micro Devices, Inc., Santa Clara, CA (US)

(72) Inventors: Nuwan S. Jayasena, Cupertino, CA (US); Sooraj Puthoor, Austin, TX (US); Shaizeen Dilawarhusen Aga, Santa Clara, CA (US)

(73) Assignee: Advanced Micro Devices, Inc., Santa Clara, CA (US)

(21) Appl. No.: 18/886,970

(22) Filed: Sep. 16, 2024

(51) Int. Cl. H04L 9/08; G06F 21/60; H04L 9/14

(52) U.S. Cl. CPC H04L 9/0891; G06F 21/602; H04L 9/14

(57) ABSTRACT

Selective encryption for processing-in-memory is described. In implementations, an encryption scheme used by a host processing device is different than an encryption scheme used by a memory device coupled to the host processing device. By designating data elements for encryption using a memory encryption scheme, the host processing device offloads encryption of the data elements to a memory device. Offloading encryption to the memory device enables the memory device to retrieve encrypted data from memory, decrypt the data, perform one or more processing-in-memory operations on the decrypted data using a processing-in-memory component of the memory device. Following completion of processing-in-memory operations, the memory device re-encrypts the data and stores the re-encrypted data in memory without transmitting the data to the host processing device.

### BACKGROUND

Processing-in-memory (PIM) architectures move processing of memory-intensive computations to memory. This contrasts with standard computer architectures which communicate data back and forth between a memory and a remote processing unit. In terms of data communication pathways, remote processing units of conventional computer architectures are further away from memory than processing-in-memory components.

As a result, these conventional computer architectures suffer from increased data transfer latency, which can decrease overall computer performance and increase energy cost. Further, due to the proximity to memory, PIM architectures can also provision higher memory bandwidth and reduced memory access energy relative to conventional computer architectures particularly when the volume of data transferred between the memory and the remote processing unit is large. Thus, processing-in-memory architectures enable increased energy efficiency (e.g., performance per Watt, computation per Joule, etc.) while reducing data transfer latency as compared to conventional computer architectures that implement remote processing hardware.

### BRIEF DESCRIPTION OF THE DRAWINGS

FIG. 1 is a block diagram of an example system configured to implement the selective encryption for processing-in-memory techniques described herein.

FIG. 2 depicts an example of selective encryption by either a host device or a memory for processing-in-memory operations.

FIG. 3 depicts an example of executing processing-in-memory commands using memory-encrypted data.

FIG. 4 depicts a procedure in an example implementation of selectively applying a host-side encryption to data elements before writing the data elements to memory.

FIG. 5 depicts a procedure in an example implementation of executing a processing-in-memory command using memory-encrypted data.

FIG. 6 depicts a procedure in an example implementation of servicing a data request from a host device for data elements that are selectively encrypted in memory using a host-side encryption scheme or a memory-side encryption scheme.

FIG. 7 is a block diagram of a processing system configured to execute one or more applications, in accordance with one or more implementations.

### DETAILED DESCRIPTION

Processing-in-memory (PIM) incorporates processing capability within memory devices so that tasks are processed directly within the memory devices, in contrast to conventional computing architectures where host devices retrieve data from memory devices to process the tasks. PIM techniques also refer to incorporation of processing capability near memory devices so that tasks are also processed without costly round-trip transmission to host processors or other distant computing units. PIM techniques are configurable to trigger local computations at multiple memory devices in parallel without involving data movement across a memory-host interface, which improves performance, especially for data-intensive workloads such as machine learning.

One of the technical problems with offloading computations to memory (e.g., from a host device to a memory device, using PIM techniques) is that secure computing environments encrypt data at a host device before the host device writes the data to memory. One approach for performing PIM operations using data stored in memory as encrypted by a host device is to use homomorphic encryption techniques. When using homomorphic encryption, a PIM component performs operation on host device-encrypted data in memory, without first decrypting the encryption applied by the host device. However, homomorphic encryption techniques incur high overhead (e.g., require increased processing time, consume significant amounts of energy, etc.), which negates many computational benefits achieved from PIM.

As an alternative to homomorphic encryption, some conventional approaches share an encryption algorithm and encryption key used by a host processor with a memory device so that a PIM component can locally decrypt data that was encrypted by the host processor. These conventional approaches are problematic in many implementations, particularly where a host device and a memory device are manufactured by different entities. For instance, sharing encryption algorithms and keys between host and memory devices manufactured by different entities necessitates that the different entities share or otherwise implement standardized encryption schemes. Such standardization of encryption schemes is impractical, as doing so would impart significant computational expense (e.g., processing power and energy consumption) on memory devices, due to specific types of block cypher encryption used by processing devices, which does not efficiently translate to the comparatively high bandwidth of PIM techniques.

As an alternative to sharing encryption keys and algorithms between memory and processing devices, a proposal for the Compute Express Link (CXL) standard includes using different initiator-based encryption and target-based encryption schemes for connected central processing units and memory endpoints. However, in contrast to the techniques described herein, CXL involves a packet-based transaction approach that involves communication of a multi-bit security key identifier that is included in every read transaction and every write transaction between the central processing unit and memory endpoints. The packet-based transaction approach of CXL differs from fixed-timing memory interfaces, and is thus not extendable to systems having fixed-timing interfaces between a processing device and main memory. Further, using initiator-based encryption and target-based encryption schemes under the CXL standard requires increased interface size (e.g., additional silicon area) relative to that of a fixed-timing interface, and is thus detrimental to implementations seeking to minimize device size.

To overcome these shortcomings facing conventional systems, selective encryption for processing-in-memory is described. The described techniques involve decoupling an encryption scheme used by a host processing device from that of an encryption scheme used by a processing-in-memory component of a memory device coupled to the host processing device. Advantageously, the described techniques enable the host processing device to specify, for individual data elements (e.g., individual elements of a single row of data stored in memory), whether the data element is to be encrypted in memory using a host encryption scheme or a memory encryption scheme.

By designating data elements for encryption using a memory encryption scheme, the host processing device offloads encryption of the data elements to a memory device. Offloading encryption to the memory device enables cryptographic circuitry of the memory device to retrieve encrypted data from memory and decrypt the data. The decrypted data is then provided to a PIM component of the memory device, which performs one or more PIM operations on the decrypted data. After completing PIM operations, the cryptographic circuitry of the memory device re-encrypts the data and store the re-encrypted data in memory. Advantageously, the retrieval of data from memory, decryption, performance of PIM operations, re-encryption, and storage of the data back in memory are performed independent of (e.g., without) having to transmit the data to the host processing device (e.g., via an interface connecting the PIM component and host processing device).

To protect data that is designated for encryption by a memory device and thus not encrypted by a host processing device, the described techniques include applying an interface encryption to data communicated between the host processing device and the memory device. In implementations, the interface encryption is applied based on a shared encryption scheme (e.g., a same encryption algorithm and a same encryption key) between the host processing device and the memory device. Upon receipt of data (e.g., from the host processing device via an interface), the memory device decrypts the interface decryption from the data. Data that is encrypted by the host processing device is written to memory as encrypted by the host processing device. Data that is unencrypted by the host processing device, other than the interface encryption, is encrypted by the memory device and written to memory as encrypted by the memory device. The memory device is then able to locally execute (e.g., using a PIM component) one or more operations of a PIM command using data encrypted by the memory device independent of (e.g., without) transmitting data to the host processing device or otherwise involving the host processing device in decrypting data utilized for the PIM command.

In this manner, the described techniques avoid the computational delays and energy consumption requirements of conventional systems that encrypt data on a host device and require decryption of the data by the host device before operations involving the data can be executed. By enabling the memory device to employ a distinct encryption scheme (e.g., different encryption key, different encryption algorithm, or combinations thereof) than a host processing device, the described techniques enable the memory device to independently decrypt, operate on, and encrypt data in a manner that maintains a secure computing environment.

In some aspects, the techniques described herein relate to a device including a memory and cryptographic circuitry configured to receive, from a host device, a first data element encrypted by the host device and a second data element designated for encryption by the cryptographic circuitry, encrypt the second data element and store, in the memory, the first data element as encrypted by the host device and the second data element as encrypted by the cryptographic circuitry.

In some aspects, the techniques described herein relate to a device, wherein the cryptographic circuitry receives the first data element and the second data element as encrypted by an interface encryption, the cryptographic circuitry further configured to decrypt the interface encryption from the first data element before storing the first data element, and decrypt the interface encryption from the second data element before encrypting and storing the second data element.

In some aspects, the techniques described herein relate to a device, further including a processing-in-memory component configured to execute a processing-in-memory command by causing retrieval of the second data element from the memory, causing decryption of the second data element, performing at least one processing-in-memory operation using the second data element, causing re-encryption of the second data element, and causing storage of the re-encrypted second data element in the memory.

In some aspects, the techniques described herein relate to a device, wherein performing the at least one processing-in-memory operation includes modifying the second data element before causing re-encryption of the second data element.

In some aspects, the techniques described herein relate to a device, wherein the at least one processing-in-memory operation is performed independent of communicating the second data element to the host device.

In some aspects, the techniques described herein relate to a device, wherein the at least one processing-in-memory operation is performed independent of the host device decrypting the second data element.

In some aspects, the techniques described herein relate to a device, wherein the first data element and the second data element are elements of a single row of data in the memory.

In some aspects, the techniques described herein relate to a device, the cryptographic circuitry further configured to receive an indication that the second data element is designated for encryption by the cryptographic circuitry as part of a row activation command from the host device.

In some aspects, the techniques described herein relate to a device, wherein the first data element is encrypted by the host device using a first encryption key and the second data element is encrypted by the cryptographic circuitry using a second encryption key that is different than the first encryption key.

In some aspects, the techniques described herein relate to a device, wherein the host device and the device are connected by an interface and data communicated via the interface is encrypted using a third encryption key that is different than the first encryption key and different than the second encryption key.

In some aspects, the techniques described herein relate to a device, wherein the first data element is encrypted by the host device using a first algorithm and the second data element is encrypted by the cryptographic circuitry using a second algorithm that is different than the first algorithm.

In some aspects, the techniques described herein relate to a device, the cryptographic circuitry further configured to receive, from the host device, an encryption key for encrypting data in the memory and encrypt the second data element using the encryption key.

In some aspects, the techniques described herein relate to a device, further including key generation circuitry disposed in the memory or near the memory, the key generation circuitry configured to generate a memory encryption key, wherein the cryptographic circuitry encrypts the second data element using the memory encryption key.

In some aspects, the techniques described herein relate to a device, wherein the encryption circuitry is further configured to receive an indication that memory-side encryption is to be applied to the second data element, and based on the indication and prior to receipt of the second data element, perform a first portion of encryption operations that are used to encrypt the second data element.

In some aspects, the techniques described herein relate to a system including a host device that includes at least one processing unit configured to encrypt a first data element using a host encryption key, and transmit the first data element and a second data element to a memory device, an interface connecting the host device and the memory device, and the memory device that includes a memory and a processing-in-memory component, the memory device configured to encrypt the second data element using a memory encryption key, and store, in the memory, the first data element as encrypted by the host device and the second data element as encrypted by the memory device.

In some aspects, the techniques described herein relate to a system, wherein the host encryption key and the memory encryption key are different encryption keys.

In some aspects, the techniques described herein relate to a system, wherein the at least one processing unit is further configured to encrypt the first data element and the second data element with an interface encryption, wherein the memory device is further configured to remove the interface encryption from the first data element and the second data element before storing the first data element in the memory and before encrypting and storing the second data element in the memory.

In some aspects, the techniques described herein relate to a system, wherein the at least one processing unit is further configured to transmit a row activation command to the memory device via the interface and instruct, based on a bit in the row activation command, the memory device to encrypt the second data element using the memory encryption key.

In some aspects, the techniques described herein relate to a method including encrypting, by a processing device, a first data element using a first encryption key, transmitting, by the processing device and to a memory device, the first data element as encrypted by the processing device, transmitting, by the processing device and to the memory device, a second data element, and causing, by the processing device storage of the first data element in the memory device as encrypted by the processing device, encryption, by memory device, of the second data element using a second encryption key, and storage of the second data element in the memory device as encrypted by the memory device.

In some aspects, the techniques described herein relate to a method, further including causing a processing-in-memory component of the memory device to execute a processing-in-memory command using the second data element by causing the memory device to decrypt the second data element using the second encryption key, causing the processing-in-memory component to perform at least one operation using the second data element, causing the memory device to re-encrypt the second data element using the second encryption key, and causing the memory device to store the re-encrypted second data element in the memory device.

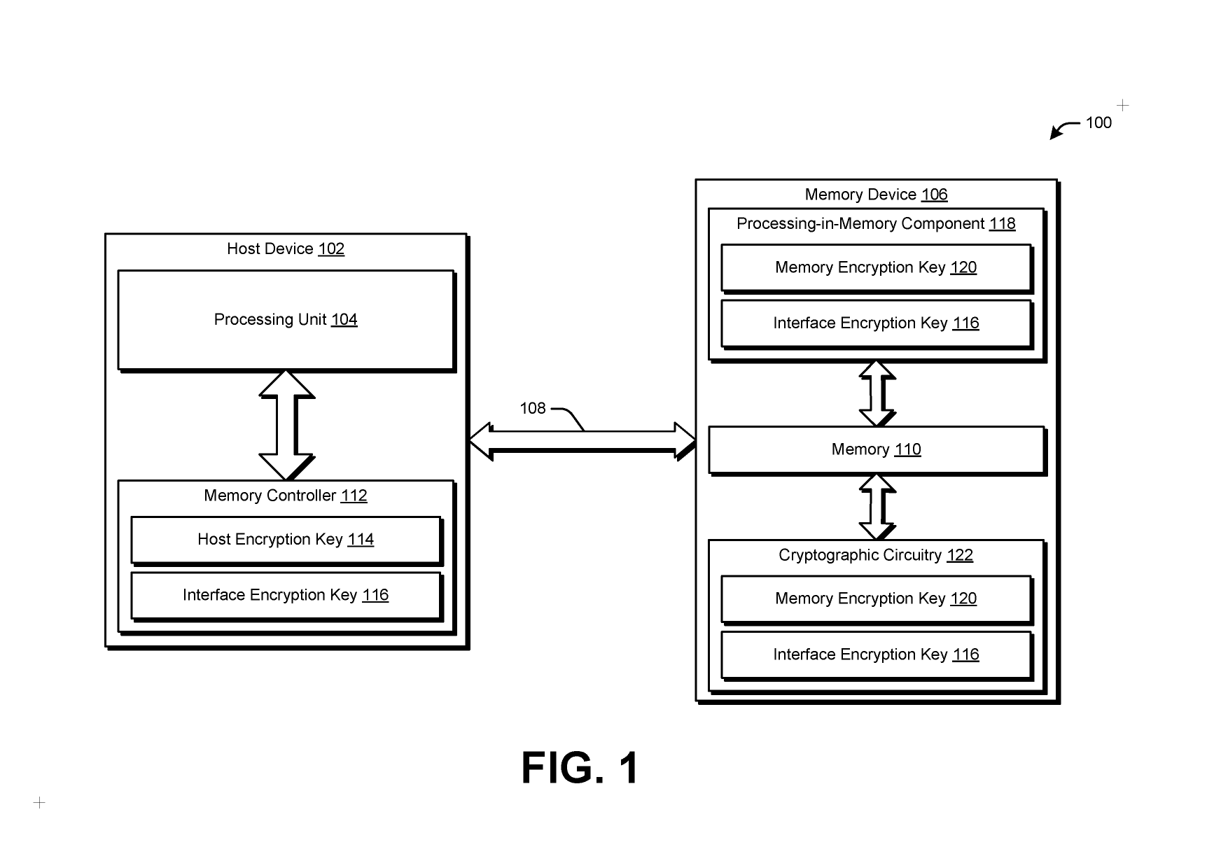

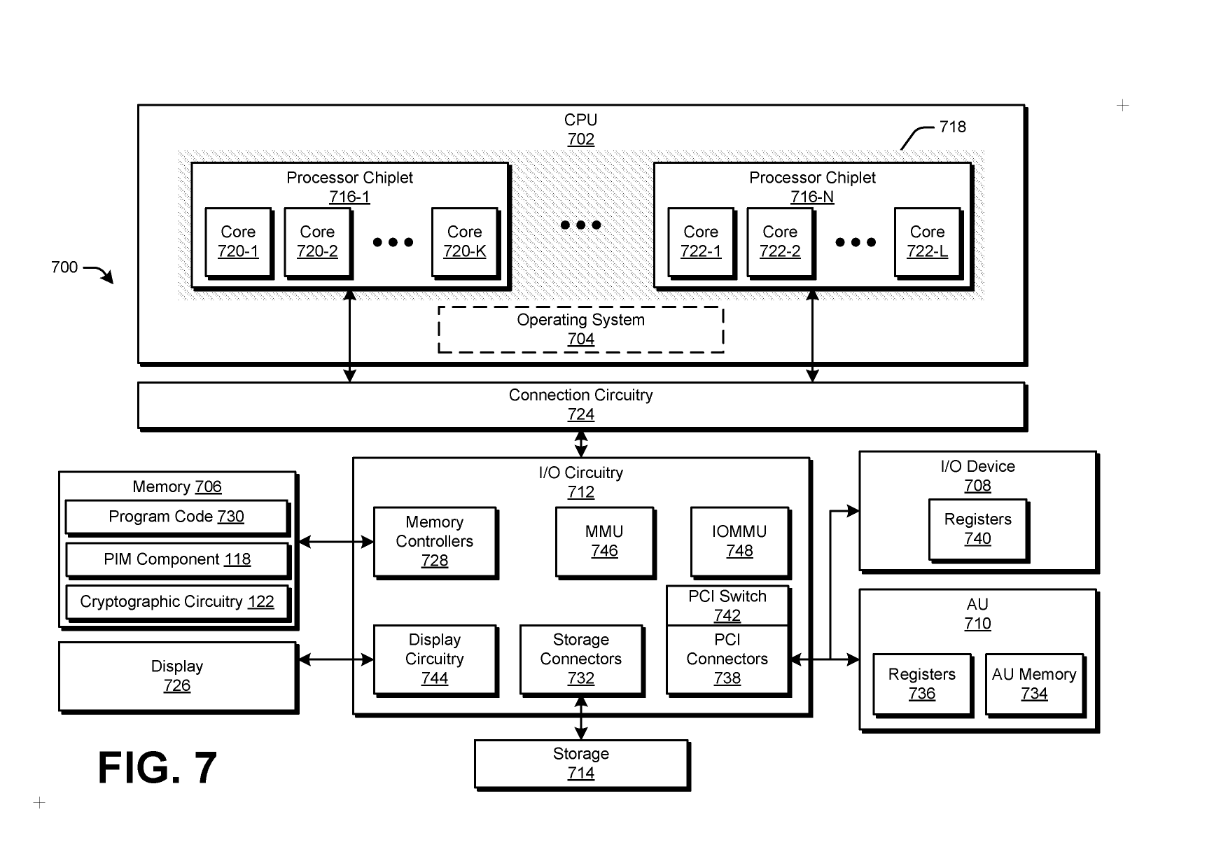

FIG. 1 is a block diagram of an example system 100 configured to implement the selective encryption for processing-in-memory techniques described herein. In the illustrated example of FIG. 1, the system 100 includes a host device 102 with at least one processing unit 104 that is coupled to a memory device 106 via an interface 108. The system 100, the processing unit 104, the memory device 106, and the interface 108 are each representative of a range of different hardware configurations, as described in further detail below with respect to FIG. 7.

In one or more implementations, the memory device 106 is a circuit board (e.g., a printed circuit board) on which memory 110 (e.g., physical memory such as dynamic random-access memory) is mounted. Alternatively, in some implementations, the memory device 106 is an integrated circuit or physical chip in which memory 110 is incorporated. The host device 102 includes a memory controller 112, which is a digital circuit (e.g., implemented in hardware) that manages the flow of data to and from the memory 110. By way of example, the memory controller 112 includes logic to read from, and write to, the memory 110. Using the techniques described herein, the memory controller 112 is further configured to encrypt data before transmitting data to the memory device 106 via the interface 108. In a similar manner, the memory controller 112 is configured to decrypt data received from the memory device 106 via the interface 108. To do so, the memory controller 112 is configured to implement multiple encryption schemes, represented in the illustrated example of FIG. 1 by host encryption key 114 and interface encryption key 116.

As described herein, an encryption scheme refers to a framework or protocol that defines how data is converted from an unencrypted form (e.g., plaintext) to an encrypted form (e.g., ciphertext), and vice versa. Generally, an encryption scheme involves an encryption algorithm using a secret value (e.g., a “key” value such as the host encryption key 114 or the interface encryption key 116) to transform an unencrypted data element into a secure form (e.g., an encrypted form). In contrast to an unencrypted form, the secure form ensures that the data cannot be accessed without knowledge of a specific encryption algorithm and key value combination. In accordance with the described techniques, an encryption scheme refers to any suitable combination of encryption key and encryption algorithm, such as Advanced Encryption Standard (AES), Rivest-Shamir-Adleman (RSA), Blowfish, Elliptic Curve Cryptography (ECC), Triple Data Encryption Standard (3DES), and so forth.

The memory controller 112 is configured to encrypt data before transmitting the data to the memory device 106 using the interface encryption key 116 and optionally the host encryption key 114. Although only a single host encryption key 114 is depicted in the illustrated example of FIG. 1, in implementations the memory controller 112 is configured to utilize a plurality of different host encryption keys 114. For instance, in an example implementation where the host device 102 employs separate processing units 104, different virtual machines, different threads, or otherwise partitions computational activity of the host device 102, the memory controller 112 is configured to implement a separate host encryption key 114 for each partition.

Use of the host encryption key 114 by the memory controller 112 is selectively indicated by the host device 102, such as for data elements being written to memory 110 by the host device 102 that will not be involved in the execution of a processing-in-memory command (e.g., by a processing-in-memory component 118 of the memory device 106) before the data elements are read from the memory 110 by the host device 102. In implementations where the processing unit 104 is informed that one or more data elements will be involved executing an upcoming processing-in-memory operation (e.g., by an application through the use of application programming interfaces (APIs), system software calls, runtime system calls, software hints, compiler-generated directives, prefetch instructions, memory hints, data dependency annotations, and so forth), the memory controller 112 abstains from encrypting the one or more data elements using the host encryption key 114.

In a similar manner, in some implementations where it is uncertain whether one or more data elements will be involved in executing an upcoming processing-in-memory operation, the memory controller 112 is configured to not apply host-side encryption using the host encryption key 114. Alternatively or additionally, an application executed by the host device 102 selectively indicates one or more data elements to be encrypted by the host device 102, or encrypted by the memory device 106, during memory allocation calls. Such scenarios represent example cases where applications executed by the host device 102 dictate what data elements, or data structures comprising multiple data elements, are to be encrypted by the memory device 106 rather than the host device 102. Alternatively or additionally, in some implementations all data elements allocated for a certain process, virtual machine, or other partition of the host device 102 are designated by the system 100 for encryption by the memory device 106 when written to memory 110 rather than encrypted by the host device 102.

In implementations, the memory controller 112 applies an interface encryption to data elements written to the memory 110 via interface 108 using the interface encryption key 116 (e.g., the memory controller 112 applies an interface encryption to data elements encrypted using the host encryption key 114 as well as data elements designated for encryption by the memory device 106). The interface encryption key 116 represents an encryption key for a secure cipher, such as an AES counter-mode cipher or another cipher that reduces added latency for data communications between the host device 102 and the memory device 106 via the interface 108. The interface encryption key 116 represents a shared encryption key between the host device 102 and the memory device 106, as represented by the inclusion of the interface encryption key 116 in the processing-in-memory component 118. In implementations, the interface encryption key 116 is generated and communicated from the host device 102 to the memory device 106 at boot time for the system 100 using any suitable secure key exchange protocol. By sharing the interface encryption key 116, the memory controller 112 is configured to encrypt data elements prior to transmission via the interface 108 and the memory device 106 is configured to decrypt the data elements upon receipt, thus preserving a security integrity of data elements while inflight via the interface 108.

The processing-in-memory component 118 is implemented in hardware (e.g., as an integrated circuit) configured to perform operations responsive to processing-in-memory commands (e.g., received from the processing unit 104). The processing-in-memory component 118 is representative of a processor with example processing capabilities ranging from relatively simple (e.g., an adding machine) to relatively complex (e.g., a CPU/GPU compute core). Thus, in accordance with one or more implementations, the processing-in-memory component 118 is representative of an in-memory processor (e.g., a processing unit disposed on or in the memory device 106). In an example, the processing-in-memory component 118 processes one or more operations (e.g., executes one or more instructions) of a processing-in-memory command using data stored in the memory 110.

Processing-in-memory contrasts with standard computer architectures which obtain data from memory, communicate the data to a remote processing unit (e.g., the processing unit 104), and process the data using the remote processing unit (e.g., using the processing unit 104 rather than the processing-in-memory component 118). In various scenarios, the data produced by the remote processing unit as a result of processing the obtained data is written back to memory 110, which involves communicating the produced data from the remote processing unit to memory 110 (e.g., via the interface 108).

In terms of data communication pathways, the remote processing unit (e.g., the processing unit 104) is further away from the memory 110 than the processing-in-memory component 118. As a result, conventional computer architectures suffer from increased data transfer latency, reduced data communication bandwidth, and increased data communication energy, particularly when the volume of data transferred between the memory 110 and the remote processing unit is large, which can also decrease overall computer performance. Thus, the processing-in-memory component 118 enables increased computer performance while reducing data transfer energy as compared to conventional computer architectures that implement remote processing hardware. Further, the processing-in-memory component 118 alleviates memory performance and energy bottlenecks by moving one or more memory-intensive computations closer to the memory 110.

Although the processing-in-memory component 118 is illustrated as being disposed within the memory device 106 (e.g., within a same integrated circuit or on a same printed circuit board), other examples are also contemplated in accordance with the described techniques. The processing-in-memory component 118, for instance, is also configurable to incorporate processing capability near memory devices so that tasks are also processed without costly round-trip transmission to host processors or other distant computing units.

Upon receipt of data from the host device 102 via the interface 108, the processing-in-memory component 118 is configured to remove an interface decryption from the received data using the interface encryption key 116. Following decryption of the interface encryption, data elements that were encrypted by the host device 102 using the host encryption key 114 are written to the memory 110 without further encryption or decryption. Conversely, data elements that were not encrypted using the host encryption key 114 are encrypted by the processing-in-memory component 118 using a memory encryption key 120. After being encrypted by the processing-in-memory component 118 using the memory encryption key 120, the data elements are written to memory 110 as encrypted by the memory device 106.

Alternatively, in some implementations the memory device 106 employs cryptographic circuitry 122, separate from the processing-in-memory component 118, that handles encryption and decryption of data in the memory device 106. The cryptographic circuitry 122 is representative of hardcoded circuitry in the memory device 106 that physically occupies less area in the memory device 106 relative to the processing-in-memory component 118. Additionally, the cryptographic circuitry 122 consumes reduced power relative to the processing-in-memory component 118 for encryption and decryption operations.

In implementations where the memory device 106 employs cryptographic circuitry 122 to handle data encryption and decryption, the cryptographic circuitry 122 is configured to remove an interface decryption from the received data using the interface encryption key 116. Following decryption of the interface encryption, data elements that were encrypted by the host device 102 using the host encryption key 114 are written to the memory 110 independent of (e.g., without) further encryption or decryption. Conversely, data elements that were not encrypted using the host encryption key 114 are encrypted by the cryptographic circuitry 122 using a memory encryption key 120. After being encrypted by the cryptographic circuitry 122 using the memory encryption key 120, the data elements are written to memory 110 as encrypted by the memory device 106.

In implementations where the memory device 106 is a circuit board (e.g., a printed circuit board) on which memory 110 (e.g., physical memory such as dynamic random-access memory) is mounted, the processing-in-memory component 118 and the cryptographic circuitry 122 are similarly mounted on the circuit board. Alternatively, in implementations where the memory device 106 is an integrated circuit or physical chip in which memory 110 is incorporated, the processing-in-memory component 118 and the cryptographic circuitry 122 are similarly incorporated in the integrated circuit or physical chip. In implementations, the host device 102 securely communicates the memory encryption key 120 to the memory device 106 using a known secure key exchange protocol. In some implementations, the host device 102 employs a security processor or an encryption block of circuitry that is dedicated to generating keys for the system (e.g., the host encryption key 114, the interface encryption key 116, and the memory encryption key 120). The host encryption key 114, the interface encryption key 116 and the memory encryption key 120 each represent encryption schemes, such that at least one of an encryption key or an encryption algorithm for each respective encryption scheme differs from that of any other encryption scheme. Alternatively or additionally, in some implementations the memory device 106 includes key generation circuitry, either disposed in memory 110 or near the memory 110 (e.g., implemented by the processing-in-memory component 118 or the cryptographic circuitry 122), that is configured to generate the memory encryption key 120.

Upon receipt of a PIM command (e.g., from the host device 102 via the interface 108), the processing-in-memory component 118 is configured to execute one or more operations of the PIM command using memory-side encrypted data elements without transmitting the encrypted data elements to the host device 102. For instance, the processing-in-memory component 118 executes a PIM command by reading memory-side encrypted data from the memory 110, decrypting the data using the memory encryption key 120, performing one or more operations using the decrypted data, re-encrypting the data, and writing the re-encrypted data to memory 110. Alternatively, in some implementations, the processing-in-memory component 118 executes a PIM command by causing the cryptographic circuitry 122 to decrypt the data using the memory encryption key 120 before the processing-in-memory component 118 executes one or more operations of the PIM command. After executing the one or more operations of the PIM command, the memory device 106 tasks the cryptographic circuitry 122 with re-encrypting the data, such that encryption and decryption in the memory device 106 is offloaded from the processing-in-memory component 118 to the cryptographic circuitry 122. In some implementations, performing one or more operations of a PIM command involves modifying at least one data element, such that a re-encrypted data element following completion of executing the PIM command has a different value than it had as encrypted prior to initiation of the PIM command.

When data is read from memory 110 by the host device 102, the memory device 106 is configured to remove any memory-side encryption from read data elements using the memory encryption key 120 before communicating the requested data to the host device 102 via the interface 108. Further, the memory device 106 is configured to preserve a security integrity of data communicated via the interface 108 by applying an interface encryption using the interface encryption key 116 to data elements communicated from the memory device 106 to the host device 102 via the interface 108. In this manner, the system 100 ensures a secure computing environment by selectively applying host-side or memory-side encryption schemes to data elements based on the data elements being involved in a processing-in-memory operation.

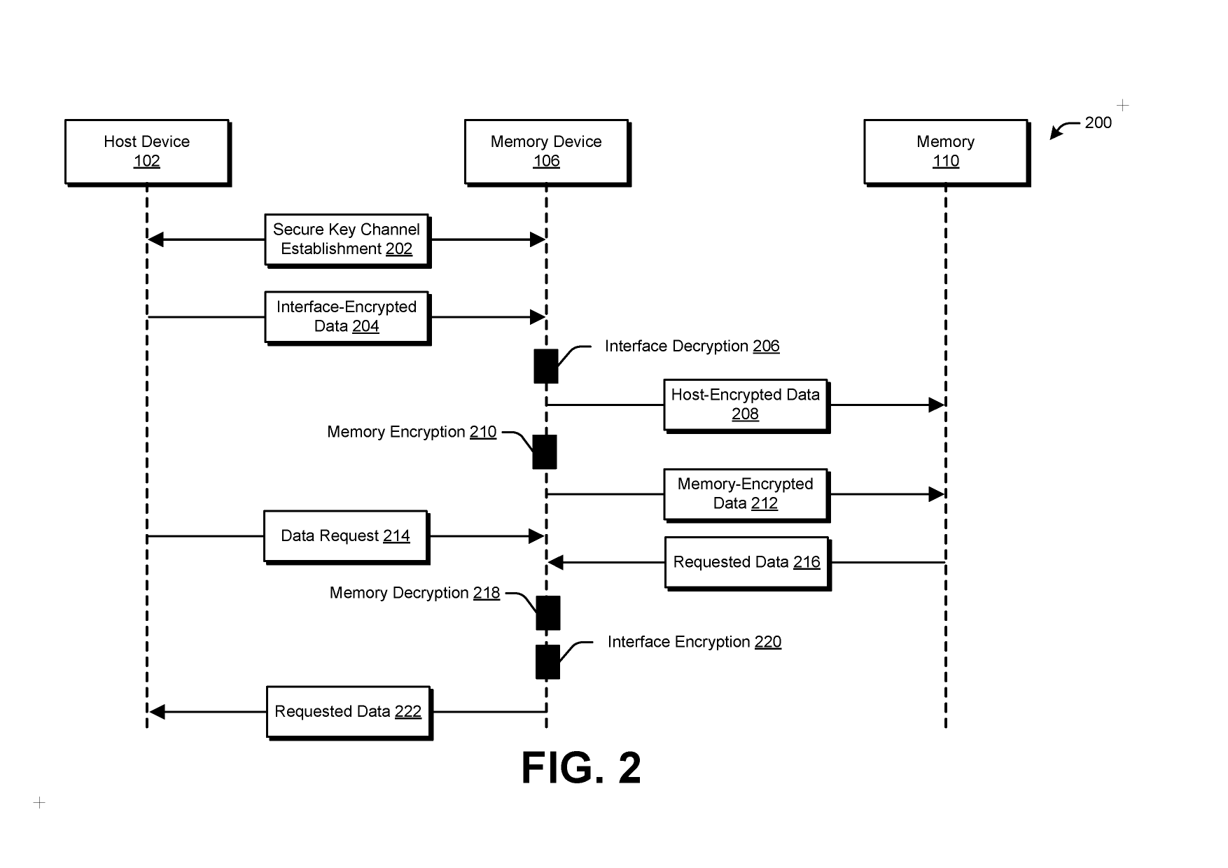

FIG. 2 depicts an example 200 of selective encryption by either a host device or a memory device for processing-in-memory operations. The example 200 is depicted as including the host device 102, the memory device 106, and the memory 110 of FIG. 1. Prior to communication of data between the host device 102 and the memory 110, a secure key channel establishment 202 occurs between the host device 102 and the memory device 106. The secure key channel establishment 202, for instance, refers to the host device 102 establishing a secure, authenticated communication channel for exchanging encryption keys with the memory device 106 (e.g., with the processing-in-memory component 118, with the cryptographic circuitry 122, or combinations thereof). The secure and authenticated communication channel established between the host device 102 and the memory device 106 is a logical channel, and in some implementations is represented by the interface 108 by which data is communicated between the host device 102 and the memory device 106. Alternatively, in some implementations the authenticated encryption key communication channel is a separate interface between the host device 102 and the memory device 106. The host device 102 is configured to perform the secure key channel establishment 202 using any suitable key exchange protocol upon initialization of the system 100. In some implementations, the system 100 is restricted to having a single authenticated encryption key communication channel between the host device 102 and the memory device 106.

As part of performing the secure key channel establishment 202, the host device 102 provides the memory device 106 with the interface encryption key 116 and the memory encryption key 120 via the encryption key communication channel. As further part of performing the secure key channel establishment 202, the memory device 106 is configured to authenticate that each encryption key received via the encryption key communication channel originates from the same host device 102 as the host device 102 that established the encryption key communication channel. Upon authenticating that an encryption key originated from the same host device 102, the memory device 106 returns an acknowledgement receipt to the host device 102.

In implementations, the memory device 106 authenticates an encryption key received from the host device 102 using any suitable encryption key authentication technique. In an example scenario where the host device 102 transmits an encryption key to the memory device 106 but does not receive an acknowledgement receipt for the encryption key, the host device 102 is configured to assume that security of the system 100 has been compromised and is prevented from communicating any data to the memory device 106 unless the data has first been encrypted by the host device 102 using the host encryption key 114.

Although depicted in the illustrated example of FIG. 2 as occurring once, the host device 102 is configured to initiate a secure key channel establishment 202 with the memory device 106 at any time. In the event of a subsequent secure key channel establishment 202, the memory device 106 is configured to erase any encryption keys that were previously communicated from the host device 102 to preserve a security integrity of the system 100. By doing so, the memory device 106 ensures that an attacker is unable to establish their own keys and access the contents already stored in memory, as communication of new encryption keys constitutes a new secure key channel establishment and causes the memory device 106 (e.g., the processing-in-memory component 118 and the cryptographic circuitry 122) to delete both of the previous keys (interface encryption key 116 and the memory encryption key 120). Deletion of the interface encryption key 116 thus prevents any data from being decrypted at the memory device 106, as the shared interface encryption key 116 is no longer available. In a similar manner, upon power cycling, the memory device 106 is configured to erase any previously communicated encryption keys to protect against malicious attacks.

After completing the secure key channel establishment 202, the host device 102 transmits interface-encrypted data 204 to the memory device 106 via the interface 108. In the illustrated example of FIG. 2, the interface-encrypted data 204 includes at least one data element having a host-side encryption (e.g., as applied by the memory controller 112 using the host encryption key 114) and at least one data element designated for encryption by the memory device 106 using the memory encryption key 120. The memory device 106 (e.g., using the processing-in-memory component 118 or the cryptographic circuitry 122) is configured to perform an interface decryption 206 by removing an interface encryption from the interface-encrypted data using the interface encryption key 116. After performing the interface decryption 206, the memory device 106 is configured to write host-encrypted data 208 to the memory 110 (e.g., as encrypted by the memory controller 112 using the host encryption key 114). For any data elements of the interface-encrypted data 204 that are designated for encryption by the memory device 106, the memory device 106 performs memory encryption 210 (e.g., using the processing-in-memory component 118 or the cryptographic circuitry 122).

In some implementations, the host device 102 informs the memory device 106 as to what data elements are designated for memory encryption during row activation using a bit in a row command communicated from the host device 102 to the memory device 106 (e.g., via the interface 108). By indicating one or more data elements designated for memory-side encryption via a row command from the host device 102, the described techniques reduce interface overhead due to the nature of row commands being issued much less frequently than read/write operations (e.g., column commands) during operation of the system 100. Further, certain encryption schemes implemented by the memory device 106 require knowledge of what data elements are to be encrypted by the memory device 106 at row activation time, thus it is advantageous to communicate the indication as part of a row command.

Alternatively or additionally, an indication of data elements to be encrypted by the memory device 106 is communicated from the host device 102 via one or more additional bits on a read operation or a write operation (e.g., within a column command). Alternatively or additionally, an indication of data elements to be encrypted by the memory device 106 is communicated as part of a PIM command. For instance, in an example implementation where a PIM command is broadcast by the host device 102 to all banks of the memory 110, address bits of the PIM command that are otherwise used to identify a bank during normal memory accesses are used to indicate whether data elements are designated for host-side or memory-side encryption. Alternatively or additionally, the indication of data elements to be encrypted by the memory device 106 are communicated by the host device 102 via standalone commands, sideband interfaces, combinations thereof, and so forth.

In some implementations, the host device 102 provides an indication to the memory device 106 of data that will later be transmitted from the host device 102 to the memory device 106 for memory-side encryption and storage in memory 110. In such implementations, the prior indication of data to be encrypted by the memory device 106 enables the memory device 106 to preemptively perform one or more functions of an encryption scheme (e.g., one or more operations of an encryption algorithm that uses the memory encryption key 120), before receipt of data to be encrypted by the memory device 106. In such implementations, this preemptive information of an upcoming memory-side encryption enables the memory device 106 to minimize delay on a critical path between the host device 102 and the memory device 106 (e.g., relative to a delay resulting from the memory device 106 not initiating memory-side encryption until receiving the data to be encrypted). As a specific example, consider an implementation where the memory-side encryption scheme involving the memory encryption key 120 includes performing a plurality of encryption operations before applying an XOR operation to the data to be encrypted. In this specific example, the prior indication of an upcoming memory-side encryption enables the memory device 106 to perform the plurality of encryption operations prior to receipt of the data, such that a single XOR operation is performed to apply a memory-side encryption upon receipt of the data.

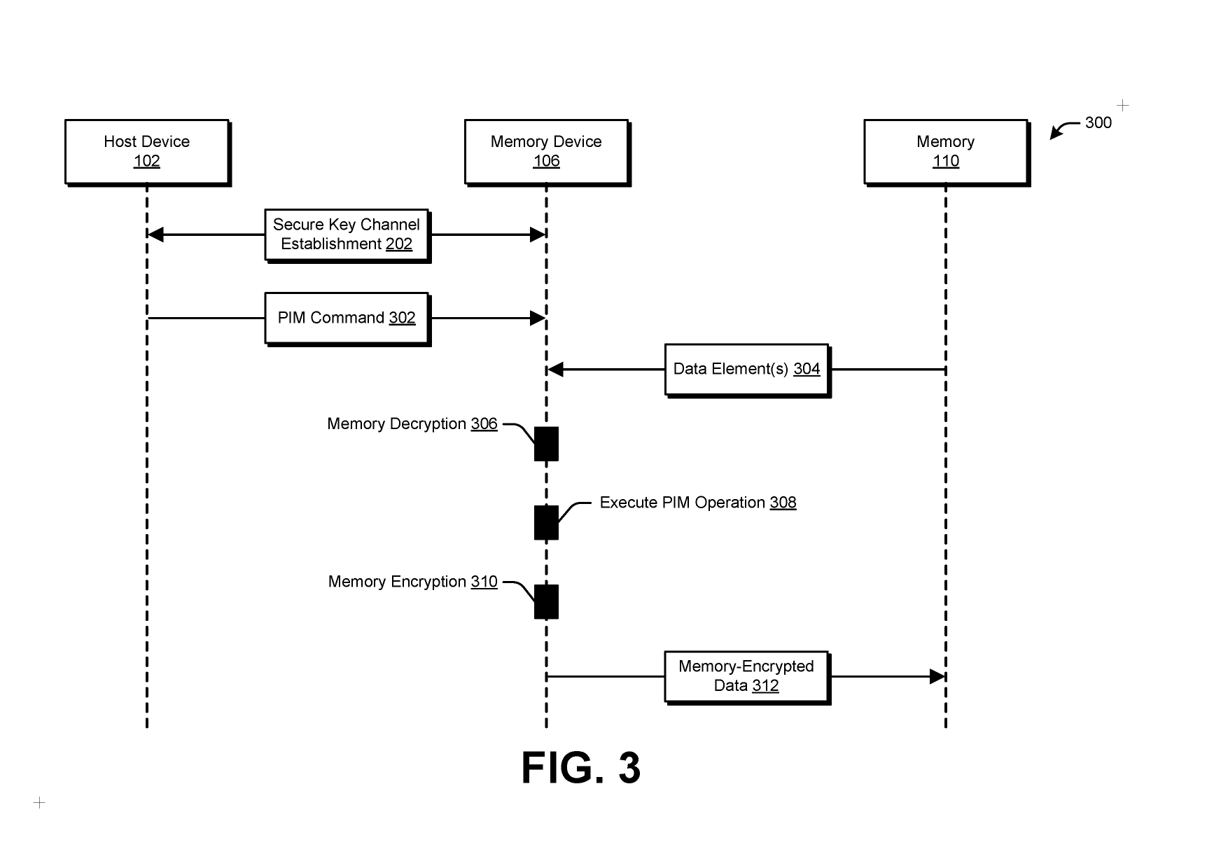

For data elements of the interface-encrypted data 204 designated for memory encryption 210, the memory device 106 (e.g., using the processing-in-memory component 118 or the cryptographic circuitry 122) generates memory-encrypted data 212 using the memory encryption key 120 and writes the memory-encrypted data 212 to memory 110. The processing-in-memory component 118 is then able to perform one or more operations of a processing-in-memory command using the memory-encrypted data 212, as described in further detail below with respect to FIG. 3.

In response to receiving a data request 214 for one or more data elements from the host device 102, the memory device 106 is configured to retrieve the one or more data elements from the memory 110, represented by the requested data 216 in the illustrated example of FIG. 2. For elements of the requested data 216 having a memory-side encryption, the memory device 106 (e.g., using the processing-in-memory component 118 or the cryptographic circuitry 122) performs a memory decryption 218 using the memory encryption key 120. The memory device 106 (e.g., using the processing-in-memory component 118 or the cryptographic circuitry 122) then applies an interface encryption 220 to all data elements of the requested data 216 using the interface encryption key 116 and communicates the interface-encrypted one or more data elements to the host device 102 as requested data 222.

FIG. 3 depicts an example 300 of executing processing-in-memory commands using memory-encrypted data. The example 300 is depicted as including the host device 102, the memory device 106, and the memory 110 of FIG. 1. Prior to communication of data between the host device 102 and the memory 110, a secure key channel establishment 202 occurs between the host device 102 and the memory device 106, as described with respect to FIG. 2. The host device 102 then issues at least one processing-in-memory command 302 to the memory device 106, which instructs the processing-in-memory component 118 to execute at least one processing-in-memory operation using one or more data elements 304. In implementations, each of the one or more data elements 304 represents a data element that is encrypted in the memory 110 by the processing-in-memory component 118 or the cryptographic circuitry 122 (e.g., using the memory encryption key 120).

To execute the at least one processing-in-memory command 302, the memory device 106 (e.g., using the processing-in-memory component 118 or the cryptographic circuitry 122) retrieves the one or more data elements 304 from the memory 110 and performs a memory decryption 306 to remove a memory-side encryption from the one or more data elements 304 using the memory encryption key 120.

The processing-in-memory component 118 then executes at least one processing-in-memory operation 308 using the decrypted one or more data elements 304. In some implementations, executing the at least one processing-in-memory operation 308 involves modifying a value or otherwise changing at least one data element of the one or more data elements 304. For instance, in some implementations a result of performing a processing-in-memory operation 308 includes generating a different data element that is written to a different data storage location than a data storage location from which the one or more data elements 304 are received. Alternatively or additionally, in some implementations a result of performing a processing-in-memory operation 308 includes outputting a different quantity of data elements than a quantity of data elements that were used as input to perform the processing-in-memory operation 308. After executing the at least one processing-in-memory operation, the memory device 106 (e.g., using the processing-in-memory component 118 or the cryptographic circuitry 122) is configured to apply a memory encryption 310 to the one or more data elements 304 (e.g., using the memory encryption key 120) to generate memory-encrypted data 312. The memory-encrypted data 312 is then written to the memory 110 as encrypted by the memory device 106.

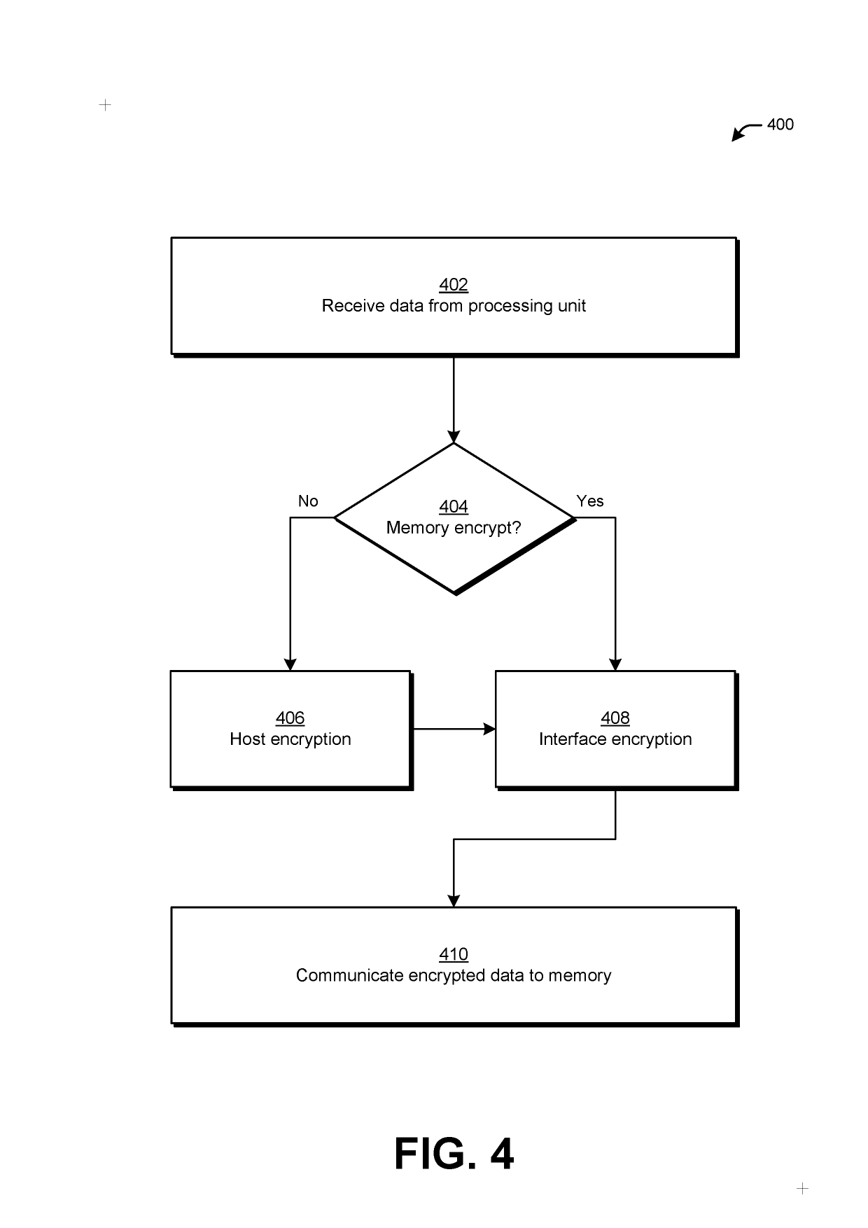

FIG. 4 depicts a procedure 400 in an example implementation of selectively applying a host-side encryption to data elements before writing the data elements to memory. To begin, data is received from a processing unit (block 402). The memory controller 112, for instance, receives at least one data element from the processing unit 104. A determination is made as to whether a memory-side encryption should be applied to the at least one data element (block 404). The processing unit 104, for instance, informs the memory controller 112 as to whether memory side encryption should be applied to the at least one data element. In response to identifying that a memory-side encryption should not be applied to the at least one data element (e.g., a “No” determination at block 404), a host encryption is applied to the at least one data element (block 406). The memory controller 112, for instance, uses the host encryption key 114 to encrypt the at least one data element.

After applying the host encryption to the at least one data element, an interface encryption is further applied to the at least one data element (block 408). The memory controller 112, for instance, uses the interface encryption key 116 to apply an interface encryption to the at least one data element. Alternatively, in response to identifying that a memory-side encryption should be applied to the at least one data element (e.g., a “Yes” determination at block 404), operation of the process 400 skips applying the host-side encryption and proceeds directly to applying the interface encryption at block 408. The encrypted data is then communicated to memory (block 410). The memory controller 112, for instance, writes interface-encrypted data 204 to the memory 110 via the interface 108.

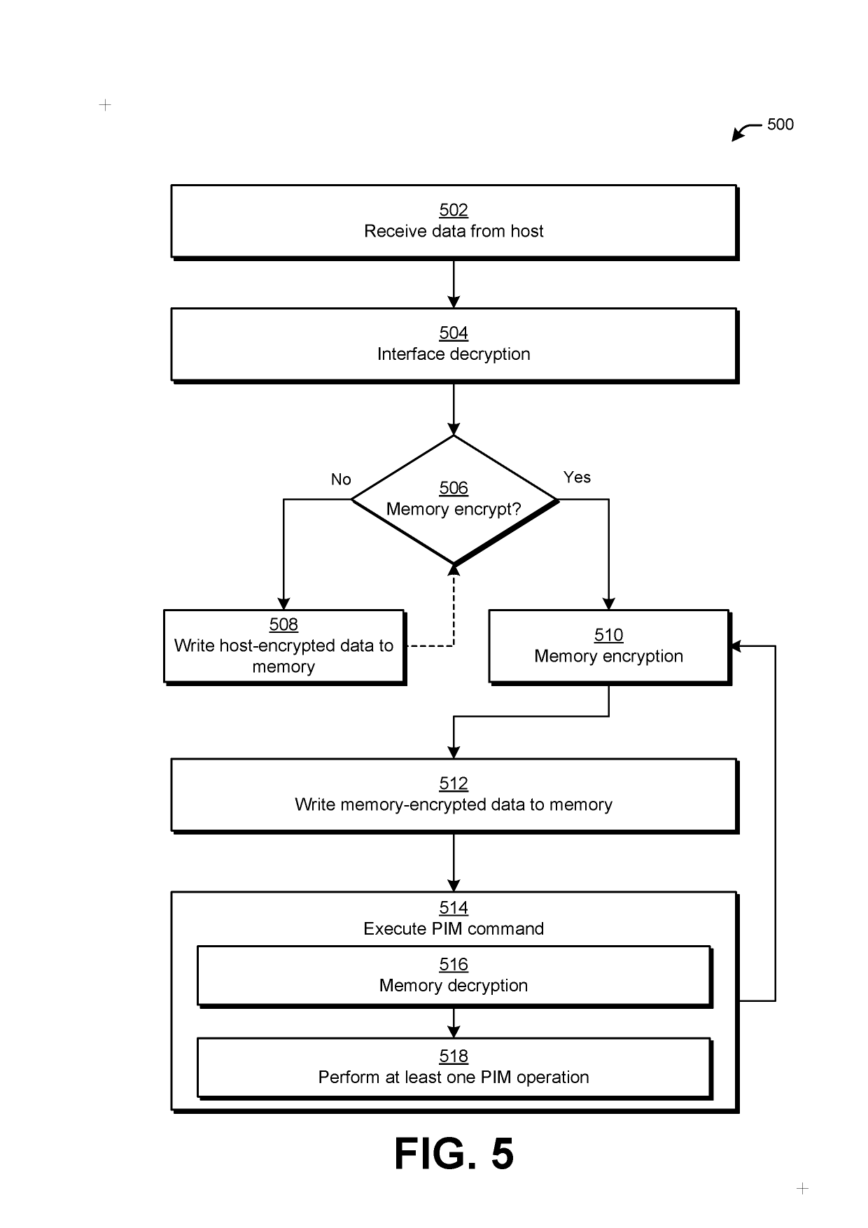

FIG. 5 depicts a procedure 500 in an example implementation of executing a processing-in-memory command using memory-encrypted data. To begin, data is received from a host (block 502). The memory device 106, for instance, receives interface-encrypted data 204 from the host device 102. An interface decryption is then performed to remove an interface encryption from the received data (block 504). The processing-in-memory component 118 or the cryptographic circuitry 122, for instance, performs interface decryption 206 using the interface encryption key 116. A determination is then made as to whether one or more of the received data elements are designated for encryption by the memory device 106 (block 506). In response to determining that one or more of the data elements are encrypted by the host device 102 (e.g., using the host encryption key 114) and thus not designated for encryption by the memory device 106 (e.g., a “No” determination at block 506), the host-encrypted data is written to memory (block 508). . Operation then optionally returns to block 506 to evaluate additional data elements, as indicated by the dashed arrow returning to block 506 from block 508, such that the determination of block 506 is performed for each received data element.

In response to determining that at least one data element is designated for encryption by the memory device 106 (e.g., a “Yes” determination at block 506), a memory encryption is applied to the at least one data element (block 510). The processing-in-memory component 118 or the cryptographic circuitry 122, for instance, performs memory encryption 210 on the at least one data element using the memory encryption key 120. The memory-encrypted data is then written to memory (block 512). The processing-in-memory component 118 or the cryptographic circuitry 122, for instance, writes memory-encrypted data 212 to the memory 110.

At least one processing-in-memory command is then executed (block 514). The processing-in-memory component 118, for instance, executes at least one processing-in-memory command 302. As part of executing the processing-in-memory command, a memory encryption on one or more data elements involved in performing at least one operation of the processing-in-memory command is decrypted (block 516). The processing-in-memory component 118 or the cryptographic circuitry 122, for instance, performs memory decryption 306 on one or more data elements 304 involved in executing the at least one processing-in-memory command 302. At least one processing-in-memory operation is then performed using the one or more data elements (block 518). The processing-in-memory component 118, for instance, executes at least one processing-in-memory operation 308. Upon completion of executing the processing-in-memory command, data elements that were decrypted at block 516, data elements that were produced as a result of executing the processing-in-memory command, or combinations thereof, are re-encrypted and written to memory, as indicated by the arrow returning to block 510 from block 514.

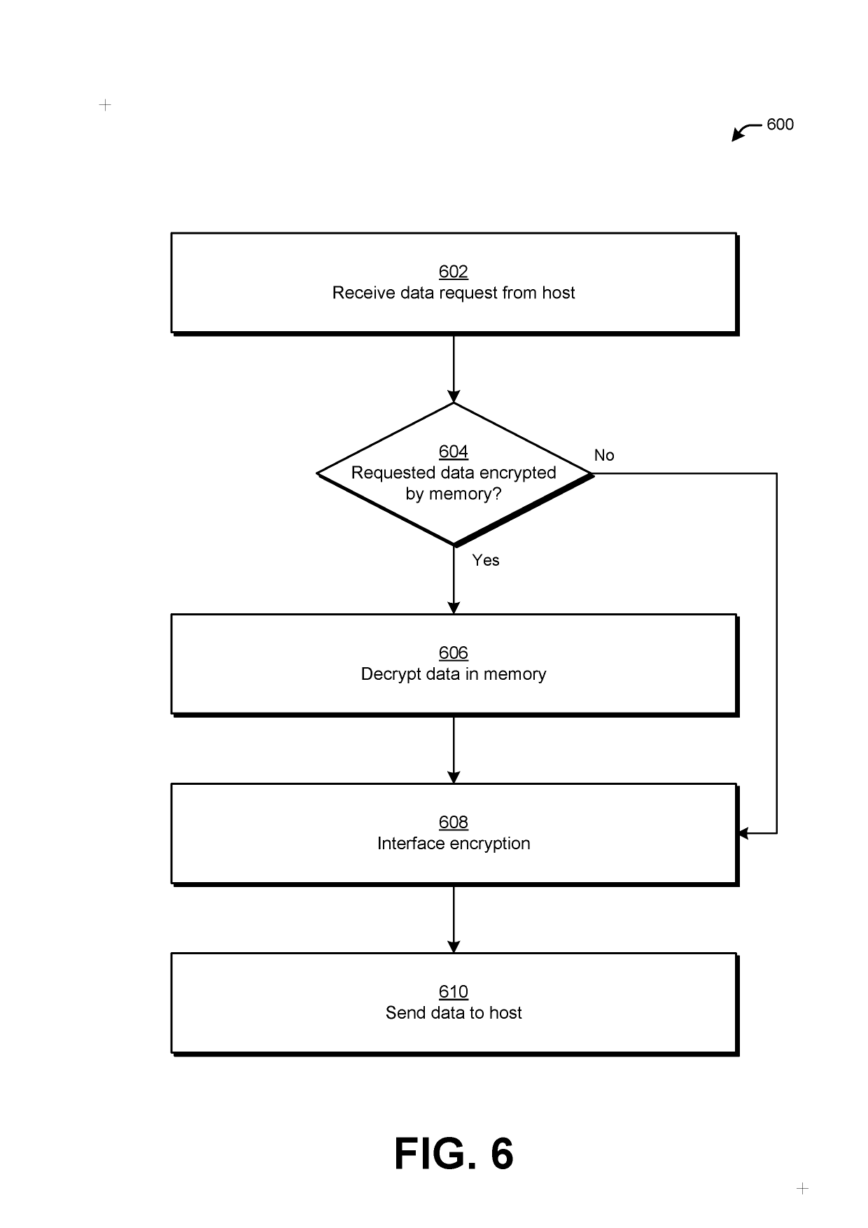

FIG. 6 depicts a procedure 600 in an example implementation of servicing a data request from a host device for data elements that are selectively encrypted in memory using a host-side encryption scheme or a memory-side encryption scheme. To begin, a data request is received from a host (block 602). The memory device 106, for instance, receives data request 214 from the host device 102. A determination is then made as to whether one or more requested data elements have been encrypted by the memory device (block 604). The processing-in-memory component 118 or the cryptographic circuitry 122, for instance, obtains requested data 216 from the memory 110 and identifies whether one or more data elements in the requested data 216 were previously encrypted at the memory device 106 using the memory encryption key 120. In response to determining that at least one data element was encrypted by the memory device (e.g., a “Yes” determination at block 604), the at least one data element is decrypted in memory (block 606). The processing-in-memory component 118 or the cryptographic circuitry 122, for instance, performs memory decryption 218 to remove a memory encryption using the memory encryption key 120. An interface encryption is then applied to the data elements requested by the host (block 608). The processing-in-memory component 118 or the cryptographic circuitry 122, for instance, applies interface encryption 220 to the requested data requested data 222. In implementations where data requested by the host has not been encrypted in memory (e.g., a “No” determination at block 604), the memory decryption 218 is unnecessary and not performed, as indicated by the arrow circumventing block 604. After applying the interface encryption to requested data element(s), the requested data is sent to the host (block 610). The memory device 106, for instance, transmits requested data 222 to the host device 102 via the interface 108.

The example techniques described herein are merely illustrative and many variations are possible based on this disclosure. Although features and elements are described above in particular combinations, each feature or element is usable alone without the other features and elements or in various combinations with or without other features and elements. In one or more implementations, the methods and procedures provided herein are implemented in a computer program, software, or firmware incorporated in a non-transitory computer-readable storage medium for execution by a general-purpose computer or a processor, such as a processing system described below with respect to FIG. 7.

FIG. 7 is a block diagram of a processing system configured to execute one or more applications, in accordance with one or more implementations.

FIG. 7 includes a processing system 700 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 700 includes a central processing unit (CPU) 702. In one or more implementations, the CPU 702 is configured to run an operating system (OS) 704 that manages the execution of applications. For example, the OS 704 is configured to schedule the execution of tasks (e.g., instructions) for applications, allocate portions of resources (e.g., system memory 706, CPU 702, input/output (I/O) device 708, accelerator unit (AU) 710, storage 714) for the execution of tasks for the applications, provide an interface to I/O devices (e.g., I/O device 708) for the applications, or any combination thereof.

In the processing system 700, the processing-in-memory component 118 and the cryptographic circuitry 122 are implemented in the memory 706, such that the memory 706 represents an instance of the memory device 106. In a similar manner, the CPU 702 represents an instance of the processing unit 104 of the host device 102.

The CPU 702 includes one or more processor chiplets 716, which are communicatively coupled together by a data fabric 718 in one or more implementations.

Each of the processor chiplets 716, for example, includes one or more processor cores 720, 722 configured to concurrently execute one or more series of instructions, also referred to herein as “threads,” for an application. Further, the data fabric 718 communicatively couples each processor chiplet 716-N of the CPU 702 such that each processor core (e.g., processor cores 720) of a first processor chiplet (e.g., 716-1) is communicatively coupled to each processor core (e.g., processor cores 722) of one or more other processor chiplets 716. Though the example implementation depicted in FIG. 7 shows a first processor chiplet (716-1) having three processor cores (720-1, 720-2, 720-K) representing a K number of processor cores 722 and a second processor chiplet (716-N) having three processor cores (e.g., 722-1, 722-2, 722-L) representing an L number of processor cores 722, in other implementations (L being an integer number greater than or equal to one), each processor chiplet 716 may have any number of processor cores 720, 722. For example, each processor chiplet 716 can have the same number of processor cores 720, 722 as one or more other processor chiplets 716, a different number of processor cores 720, 722 as one or more other processor chiplets 716, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 700, the CPU 702 is communicatively coupled to an I/O circuitry 712 by a connection circuitry 724. For example, each processor chiplet 716 of the CPU 702 is communicatively coupled to the I/O circuitry 712 by the connection circuitry 724. The connection circuitry 724 includes, for example, one or more data fabrics, buses, buffers, queues, and the like. The I/O circuitry 712 is configured to facilitate communications between two or more components of the processing system 700 such as between the CPU 702, system memory 706, display 726, universal serial bus (USB) devices, peripheral component interconnect (PCI) devices (e.g., I/O device 708, AU 710), storage 714, and the like.

As an example, system memory 706 includes any combination of one or more volatile memories and/or one or more non-volatile memories, examples of which include dynamic random-access memory (DRAM), static random-access memory (SRAM), non-volatile RAM, and the like. To manage access to the system memory 706 by CPU 702, the I/O device 708, the AU 710, and/or any other components, the I/O circuitry 712 includes one or more memory controllers 728. These memory controllers 728, for example, include circuitry configured to manage and fulfill memory access requests issued from the CPU 702, the I/O device 708, the AU 710, or any combination thereof. Examples of such requests include read requests, write requests, fetch requests, pre-fetch requests, or any combination thereof. The memory controllers 728 are configured to manage access to the data stored at one or more memory addresses within the system memory 706, such as by CPU 702, the I/O device 708, and/or the AU 710.

When an application is to be executed by processing system 700, the OS 704 running on the CPU 702 is configured to load at least a portion of program code 730 (e.g., an executable file) associated with the application from, for example, a storage 714 into system memory 706. This storage 714, for example, includes a non-volatile storage such as a flash memory, solid-state memory, hard disk, optical disc, or the like configured to store program code 730 for one or more applications.

To facilitate communication between the storage 714 and other components of processing system 700, the I/O circuitry 712 includes one or more storage connectors 732 (e.g., universal serial bus (USB) connectors, serial AT attachment (SATA) connectors, PCI Express (PCIe) connectors) configured to communicatively couple storage 714 to the I/O circuitry 712 such that I/O circuitry 712 is capable of routing signals to and from the storage 714 to one or more other components of the processing system 700.

In association with executing an application, in one or more scenarios, the CPU 702 is configured to issue one or more instructions (e.g., threads) to be executed for an application to the AU 710. The AU 710 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 710 includes one or more compute units that concurrently execute one or more threads of an application and store data resulting from the execution of these threads in AU memory 734. This AU memory 734, for example, includes any combination of one or more volatile memories and/or non-volatile memories, examples of which include caches, video RAM (VRAM), or the like. In one or more implementations, these compute units are also configured to execute these threads based on the data stored in one or more physical registers 736 of the AU 710.

To facilitate communication between the AU 710 and one or more other components of processing system 700, the I/O circuitry 712 includes or is otherwise connected to one or more connectors, such as PCI connectors 738 (e.g., PCIe connectors) each including circuitry configured to communicatively couple the AU 710 to the I/O circuitry such that the I/O circuitry 712 is capable of routing signals to and from the AU 710 to one or more other components of the processing system 700. Further, the PCIe connectors 738 are configured to communicatively couple the I/O device 708 to the I/O circuitry 712 such that the I/O circuitry 712 is capable of routing signals to and from the I/O device 708 to one or more other components of the processing system 700.

By way of example and not limitation, the I/O device 708 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 708 is configured to execute one or more operations, tasks, instructions, or any combination thereof based on one or more physical registers 740 of the I/O device 708. In one or more implementations, such physical registers 740 are configured to maintain data (e.g., operands, instructions, values, variables) indicating one or more operations, tasks, or instructions to be performed by the I/O device 708.

To manage communication between components of the processing system 700 (e.g., AU 710, I/O device 708) that are connected to PCI connectors 738, and one or more other components of the processing system 700, the I/O circuitry 712 includes PCI switch 742. The PCI switch 742, for example, includes circuitry configured to route packets to and from the components of the processing system 700 connected to the PCI connectors 738 as well as to the other components of the processing system 700. As an example, based on address data indicated in a packet received from a first component (e.g., CPU 702), the PCI switch 742 routes the packet to a corresponding component (e.g., AU 710) connected to the PCI connectors 738.

Based on the processing system 700 executing a graphics application, for instance, the CPU 702, the AU 710, or both are configured to execute one or more instructions (e.g., draw calls) such that a scene including one or more graphics objects is rendered. After rendering such a scene, the processing system 700 stores the scene in the storage 714, displays the scene on the display 726, or both. The display 726, for example, includes a cathode-ray tube (CRT) display, liquid crystal display (LCD), light emitting diode (LED) display, organic light emitting diode (OLED) display, or any combination thereof. To enable the processing system 700 to display a scene on the display 726, the I/O circuitry 712 includes display circuitry 744. The display circuitry 744, for example, includes high-definition multimedia interface (HDMI) connectors, DisplayPort connectors, digital visual interface (DVI) connectors, USB connectors, and the like, each including circuitry configured to communicatively couple the display 726 to the I/O circuitry 712. Additionally or alternatively, the display circuitry 744 includes circuitry configured to manage the display of one or more scenes on the display 726 such as display controllers, buffers, memory, or any combination thereof.

Further, the CPU 702, the AU 710, or both are configured to concurrently run one or more virtual machines (VMs), which are each configured to execute one or more corresponding applications. To manage communications between such VMs and the underlying resources of the processing system 700, such as any one or more components of processing system 700, including the CPU 702, the I/O device 708, the AU 710, and the system memory 706, the I/O circuitry 712 includes memory management unit (MMU) 746 and input-output memory management unit (IOMMU) 748. The MMU 746 includes, for example, circuitry configured to manage memory requests, such as from the CPU 702 to the system memory 706. For example, the MMU 746 is configured to handle memory requests issued from the CPU 702 and associated with a VM running on the CPU 702. These memory requests, for example, request access to read, write, fetch, or pre-fetch data residing at one or more virtual addresses (e.g., guest virtual addresses) each indicating one or more portions (e.g., physical memory addresses) of the system memory 706. Based on receiving a memory request from the CPU 702, the MMU 746 is configured to translate the virtual address indicated in the memory request to a physical address in the system memory 706 and to fulfill the request. The IOMMU 748 includes, for example, circuitry configured to manage memory requests (memory-mapped I/O (MMIO) requests) from the CPU 702 to the I/O device 708, the AU 710, or both, and to manage memory requests (direct memory access (DMA) requests) from the I/O device 708 or the AU 710 to the system memory 706. For example, to access the registers 740 of the I/O device 708, the registers 736 of the AU 710, and/or the AU memory 734, the CPU 702 issues one or more MMIO requests. Such MMIO requests each request access to read, write, fetch, or pre-fetch data residing at one or more virtual addresses (e.g., guest virtual addresses) which each represent at least a portion of the registers 740 of the I/O device 708, the registers 736 of the AU 710, or the AU memory 734, respectively. As another example, to access the system memory 706 without using the CPU 702, the I/O device 708, the AU 710, or both are configured to issue one or more DMA requests. Such DMA requests each request access to read, write, fetch, or pre-fetch data residing at one or more virtual addresses (e.g., device virtual addresses) which each represent at least a portion of the system memory 706. Based on receiving an MMIO request or DMA request, the IOMMU 748 is configured to translate the virtual address indicated in the MMIO or DMA request to a physical address and fulfill the request.

In variations, the processing system 700 can include any combination of the components depicted and described. For example, in at least one variation, the processing system 700 does not include one or more of the components depicted and described in relation to FIG. 7. Additionally or alternatively, in at least one variation, the processing system 700 includes additional and/or different components from those depicted. The processing system 700 is configurable in a variety of ways with different combinations of components in accordance with the described techniques.

What is claimed is:

1. A device comprising:
a memory; and
cryptographic circuitry configured to:
receive, from a host device, a first encrypted data element and a second data element designated for encryption by the cryptographic circuitry;
encrypt the second data element; and
store, in the memory, the first encrypted data element and the second data element that is encrypted by the cryptographic circuitry.

2. The device of claim 1, wherein the first encrypted data element and the second data element are encrypted by an interface encryption, the cryptographic circuitry further configured to:
decrypt the interface encryption from the first encrypted data element before storing the first encrypted data element; and
decrypt the interface encryption from the second data element before encrypting and storing the second data element.

3. The device of claim 1, further comprising an in-memory processor processing-in-memory component configured to execute a processing-in-memory command by:
retrieving the second data element from the memory;
decrypting the second data element;
performing at least one processing-in-memory operation using the second data element;
re-encrypting the second data element; and
storing the re-encrypted second data element in the memory.

4. The device of claim 3, wherein performing the at least one processing-in-memory operation comprises modifying the second data element before re-encrypting the second data element.

5. The device of claim 3, wherein the at least one processing-in-memory operation is performed independent of communicating the second data element to the host device.

6. The device of claim 3, wherein the at least one processing-in-memory operation is performed independent of the host device decrypting the second data element.

7. The device of claim 1, wherein the first encrypted data element and the second data element are elements of a single row of data in the memory.

8. The device of claim 1, the cryptographic circuitry further configured to receive an indication that the second data element is designated for encryption by the cryptographic circuitry as part of a row activation command from the host device.

9. The device of claim 1, wherein the first encrypted data element is encrypted using a first encryption key and the second data element is encrypted by the cryptographic circuitry using a second encryption key that is different than the first encryption key.

10. The device of claim 9, wherein the host device and the device are connected by an interface and data communicated via the interface is encrypted using a third encryption key that is different than the first encryption key and different than the second encryption key.

11. The device of claim 1, the cryptographic circuitry further configured to receive, from the host device, an encryption key for encrypting data in the memory and encrypt the second data element using the encryption key.

12. The device of claim 1, further comprising key generation circuitry disposed in the memory or near the memory, the key generation circuitry configured to generate a memory encryption key, wherein the cryptographic circuitry encrypts the second data element using the memory encryption key.

13. The device of claim 1, wherein the cryptographic circuitry is further configured to:
receive an indication that memory-side encryption is to be applied to the second data element; and
based on the indication and prior to receipt of the second data element, perform a first portion of encryption operations that are used to encrypt the second data element.

14. A system comprising:
a host device that includes at least one processing unit configured to:
encrypt a first data element using a host encryption key; and
transmit the first data element and a second data element to a memory device;
an interface connecting the host device and the memory device; and
the memory device that includes a memory and an in-memory processor, the memory device configured to:
encrypt the second data element using a memory encryption key; and
store, in the memory, the first data element as encrypted by the host device and the second data element as encrypted by the memory device.

15. The system of claim 14, wherein the host encryption key and the memory encryption key are different encryption keys.

16. The system of claim 14, wherein the at least one processing unit is configured to encrypt the first data element using a first algorithm and the memory device is configured to encrypt the second data element using a second algorithm that is different than the first algorithm.

17. The system of claim 14, wherein the at least one processing unit is further configured to encrypt the first data element and the second data element with an interface encryption, wherein the memory device is further configured to remove the interface encryption from the first data element and the second data element before storing the first data element in the memory and before encrypting and storing the second data element in the memory.

18. The system of claim 15, wherein the at least one processing unit is further configured to transmit a row activation command to the memory device via the interface and instruct, based on a bit in the row activation command, the memory device to encrypt the second data element using the memory encryption key.

19. A method comprising:
encrypting, by a processing device, a first data element using a first encryption key;
transmitting, by the processing device and to a memory device, the first data element as encrypted by the processing device;
transmitting, by the processing device and to the memory device, a second data element; and
causing, by the processing device:
storage of the first data element in the memory device as encrypted by the processing device;
encryption, by memory device, of the second data element using a second encryption key; and
storage of the second data element in the memory device as encrypted by the memory device.

20. The method of claim 19, further comprising executing a processing-in-memory command using an in-memory processor of the memory device and the second data element by:
decrypting the second data element using the second encryption key;
performing at least one operation using the second data element;
re-encrypting the second data element using the second encryption key; and
storing the re-encrypted second data element in the memory device.
